(19) United States
(12) Patent Application Publication
(10) Pub. No.: US 2025/0300244 A1
(43) Pub. Date: Sep. 25, 2025

(54) BATTERY PACK AND MANUFACTURING METHOD OF BATTERY PACK

(71) Applicant: Yamaha Hatsudoki Kabushiki Kaisha, Shizuoka (JP)

(72) Inventor: Norihiro MOROZUMI, Shizuoka (JP)

(21) Appl. No.: 19/082,199

(22) Filed: Mar. 18, 2025

(30) Foreign Application Priority Data
Mar. 19, 2024 (JP) 2024-044142

(51) Int. Cl. H01M 10/42; B62J 43/13; H01M 50/213; H01M 50/284; H01M 50/293; H01M 50/507; H01M 50/516

(52) U.S. Cl. CPC H01M 10/425; H01M 50/213; H01M 50/284; H01M 50/293; H01M 50/507; H01M 50/516; B62J 43/13; H01M 2010/4278; H01M 2220/20

(57) ABSTRACT

A battery pack includes a left holder. The left holder includes a resin portion molded from resin and a plurality of lead plates held by the resin portion. The plurality of lead plates includes a first lead plate connected to a terminal of a first battery cell and a second lead plate connected to a terminal of another battery cell. In the resin portion, a through hole penetrating the resin portion in a left-right direction is formed. The through hole is located between outer edges of the two lead plates.

### CROSS-REFERENCE TO RELATED APPLICATION

The present application claims priority from Japanese application JP2024-044142 filed on Mar. 19, 2024, the content of which is hereby incorporated by reference into this application.

### BACKGROUND OF THE INVENTION

### 1. Field of the Invention

The present disclosure relates to a battery pack and a manufacturing method of the battery pack.

### 2. Description of the Related Art

A battery pack including a plurality of battery cells is mounted on electric vehicles (including four-wheeled electric vehicles, two-wheeled electric vehicles, and electric power-assisted bicycles). For example, JP 2015-053205 A and WO 2013/077205 A1 disclose a battery pack including a plurality of battery cells having a cylindrical shape. The battery pack includes a plurality of lead plates for connecting terminals of the plurality of battery cells.

In a manufacturing process of a battery pack, generally, positions of a plurality of lead plates are aligned with positions of a plurality of battery cells, and terminals of the battery cells are welded to the lead plates. Here, however, the positions of the battery cells may be misaligned with the positions of the lead plates, and a welding process may not be performed smoothly. In particular, when the number of battery cells and the number of lead plates increase, alignment in position of the battery cells and the lead plates becomes complicated.

### SUMMARY OF THE INVENTION

(1) A battery pack according to the present disclosure, as an example, includes: a plurality of battery cells each including a terminal at an end on a first side in a first direction; and a first holder disposed on the first side of the plurality of battery cells, the first holder including a resin portion molded from resin and a plurality of lead plates held by the resin portion. The plurality of battery cells includes a first battery cell and a second battery cell aligned in a second direction intersecting with the first direction. The plurality of lead plates includes a first lead plate having a first edge and a second lead plate having a second edge facing the first edge in the second direction, the first lead plate being connected to the terminal of the first battery cell, and the second lead plate being connected to the terminal of the second battery cell. In the resin portion, a first through hole penetrating the resin portion in the first direction is formed. The first through hole is located between the first edge of the first lead plate and the second edge of the second lead plate.

According to the battery pack, the manufacturing process thereof can be simplified. For example, a process in which the first holder is formed by insert molding using a base component including the plurality of lead plates connected to each other and then the lead plates connected to each other are separated with a punch inserted into the through hole can be performed. Thus, it is possible to decrease the amount of presswork required to obtain the plurality of lead plates and the number of parts required for presswork. When a position of the first holder is aligned with a position of the battery cell, positions of the plurality of lead plates coincide with positions of the battery cells. As a result, a welding operation of the lead plate and the battery cell can be facilitated.
(2) In the battery pack according to (1), the first edge of the first lead plate and the second edge of the second lead plate may each have a portion exposed inside the first through hole.
(3) In the battery pack according to (1) or (2), the plurality of battery cells may further include a third battery cell. The first battery cell, the second battery cell, and the third battery cell may be located at vertices of an equilateral triangle respectively when the plurality of battery cells is viewed in the first direction. The first through hole may be located at a center of the equilateral triangle when the plurality of battery cells is viewed in the first direction. According to the structure, a sufficient distance between the first through hole and the battery cell is secured with ease.
(4) In the battery pack according to (1) or (2), the plurality of battery cells may further include a third battery cell and a fourth battery cell. The first battery cell, the second battery cell, the third battery cell, and the fourth battery cell may be located at vertices of a square respectively when the plurality of battery cells is viewed in the first direction. The first through hole may be located at a center of the square when the plurality of battery cells is viewed in the first direction. According to the structure, a sufficient distance between the first through hole and the battery cell is secured with ease.
(5) In the battery pack according to any one of (1) to (4), the first holder may include a signal line electrically connected to a circuit board, and a third lead plate. The signal line may be disposed along a third edge of the third lead plate. In the resin portion, a second through hole penetrating the resin portion in the first direction may be formed, the second through hole being located between the signal line and the third edge of the third lead plate.

According to the structure, it is possible to enable a manufacturing method of forming the first holder by insert molding using a base component including the signal line and the lead plate connected to each other and then separating the lead plate and the signal line with a punch inserted into the second through hole. Accordingly, when the position of the first holder is aligned with the position of the battery cell, the position of the signal line can be optimized, whereby the battery pack can be easily assembled.
(6) In the battery pack according to (5), the signal line and the third edge of the third lead plate may each have a portion exposed inside the second through hole.
(7) In the battery pack according to any one of (1) to (6), a recess may be formed in the first edge of the first lead plate and an inner edge of the recess formed in the first edge may be exposed inside the first through hole. According to the structure, it is possible to shorten the distance between edges of two lead plates adjacent to each other. As a result, an area of each of the lead plates can be increased, and an electrical resistance of each of the lead plates can be lowered.
(8) In the battery pack according to (7), a recess may be formed in the second edge of the second lead plate and an inner edge of the recess formed in the second edge may be exposed inside the first through hole. According to the structure, it is possible to further shorten the distance between edges of two lead plates adjacent to each other.
(9) In the battery pack according to any one of (1) to (6), the first edge of the first lead plate may include a protrusion extending toward the second edge of the second lead plate. The protrusion may be exposed inside the first through hole.
(10) In the battery pack according to (9), a recess may be formed in the second edge of the second lead plate and the first through hole may be located between the first edge of the first lead plate and an inner edge of the recess formed in the second edge. According to the structure, it is possible to shorten the distance between the edge of the first lead plate and the edge of the second lead plate. As a result, an area of each of the lead plates can be increased, and an electrical resistance of each of the lead plates can be lowered.
(11) In the battery pack according to any one of (1) to (10), the plurality of battery cells may each include a terminal at an end on a second side in the first direction. The battery pack may include a second holder disposed on the second side of the plurality of battery cells, the second holder including a resin portion molded from resin and a plurality of lead plates held by the resin portion. The plurality of battery cells may include a fifth battery cell and a sixth battery cell. The plurality of lead plates of the second holder may include a fourth lead plate and a fifth lead plate. In the resin portion of the second holder, a third through hole penetrating the resin portion in the first direction may be formed, and the third through hole may be located between an edge of the fourth lead plate and an edge of the fifth lead plate.
(12) A manufacturing method of a battery pack according to the present disclosure, as an example, includes: a process of preparing a base component including a first lead plate, a second lead plate aligned with the first lead plate, and a first connecting portion connecting an edge of the first lead plate and an edge of the second lead plate; a molding process of forming a holder including a resin portion that holds the base component by insert molding and forming a first through hole at a position corresponding to the first connecting portion in the resin portion; and a cutting process of cutting the connecting portion with a punch inserted into the first through hole.

According to the manufacturing method, it is possible to decrease the amount of presswork required to obtain the plurality of lead plates and the number of parts required for presswork. When a position of the holder is aligned with a position of the battery cell, positions of the plurality of lead plates coincide with positions of the battery cells. As a result, a welding operation of the lead plate and the battery cell can be facilitated.
(13) The manufacturing method according to (12) may further include: a process of preparing a plurality of battery cells including a first battery cell and a second battery cell, the plurality of battery cells each including a terminal at an end on a first side in a first direction; and a process of disposing the holder on the first side of the plurality of battery cells, welding the terminal of the first battery cell to the first lead plate, and welding the terminal of the second battery cell to the second lead plate.
(14) In the manufacturing method according to (13), the plurality of battery cells may further include a third battery cell. The first battery cell, the second battery cell, and the third battery cell may be disposed at vertices of an equilateral triangle respectively when the plurality of battery cells is viewed in the first direction, and the first through hole is formed at a center of the equilateral triangle. According to the manufacturing method, a sufficient distance between the first through hole and the battery cell is secured with ease.
(15) In the manufacturing method according to (13), the plurality of battery cells may further include a third battery cell and a fourth battery cell. The first battery cell, the second battery cell, the third battery cell, and the fourth battery cell may be disposed at vertices of a square respectively when the plurality of battery cells is viewed in the first direction. The first through hole is formed at a center of the square. According to the manufacturing method, a sufficient distance between the first through hole and the battery cell is secured with ease.
(16) In the manufacturing method according to any one of (12) to (15), the base component may include a third lead plate, a signal line disposed along an edge of the third lead plate, and a second connecting portion connecting the edge of the third lead plate and the signal line. The molding process may include forming the second through hole penetrating the resin portion at a position corresponding to the second connecting portion, and the cutting process may include cutting the second connecting portion with a punch inserted into the second through hole. According to the method, when the position of the holder is aligned with the position of the battery cell, the position of the signal line can be optimized, whereby the battery pack can be easily assembled.

### BRIEF DESCRIPTION OF THE DRAWINGS

FIG. 1 is a side view of an electric bicycle on which a battery pack according to the present disclosure is mounted;

FIG. 2 is a perspective view illustrating an example of the battery pack;

FIG. 3 is an exploded perspective view of the battery pack;

FIG. 4A is a perspective view of a left holder in the battery pack;

FIG. 4B is a perspective view illustrating an inside of the left holder (a battery cell side);

FIG. 5 is an exploded perspective view illustrating a lead plate of the left holder, a battery cell, and a lead plate of a right holder;

FIG. 6 is a view illustrating a positional relationship between a battery cell, a through hole formed in a resin portion, and a welding portion;

FIGS. 7A and 7B are views for illustrating an electrical connection between the lead plate of the left holder, the battery cell, and the lead plate of the right holder;

FIG. 8 is a flowchart for illustrating a manufacturing method of the battery pack;

FIG. 9A is a view illustrating an example of a base component used in a manufacturing process of the battery pack, two adjacent lead plates being connected to each other and the two adjacent lead plates also being connected to a signal line;

FIG. 9B is a view illustrating a state in which the lead plate and the signal line illustrated in FIG. 9A are separated;

FIG. 10A is an enlarged view of a region X illustrated in FIG. 9A;

FIG. 10B is an enlarged view of a region X illustrated in FIG. 9B, the region X in FIG. 9B being the same as the region X in FIG. 9A;

FIG. 11A is an enlarged view of a region XI illustrated in FIG. 9A;

FIG. 11B is an enlarged view of a region XI illustrated in FIG. 9B, the region XI in FIG. 9B being the same as the region XI in FIG. 9A;

FIG. 12A is an enlarged view of a region XII illustrated in FIG. 9A;

FIG. 12B is an enlarged view of a region XII illustrated in FIG. 9B, the region XII in FIG. 9B being the same as the region XII in FIG. 9A;

FIGS. 13A to 13C are views for illustrating a process of cutting a connecting portion and are cross-sectional views of the left holder taken along a line XIII-XIII in FIG. 10A; and

FIG. 14 is a view illustrating a modified example of a layout of the battery cell.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises”, “comprising”, “includes”, and/or “including”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

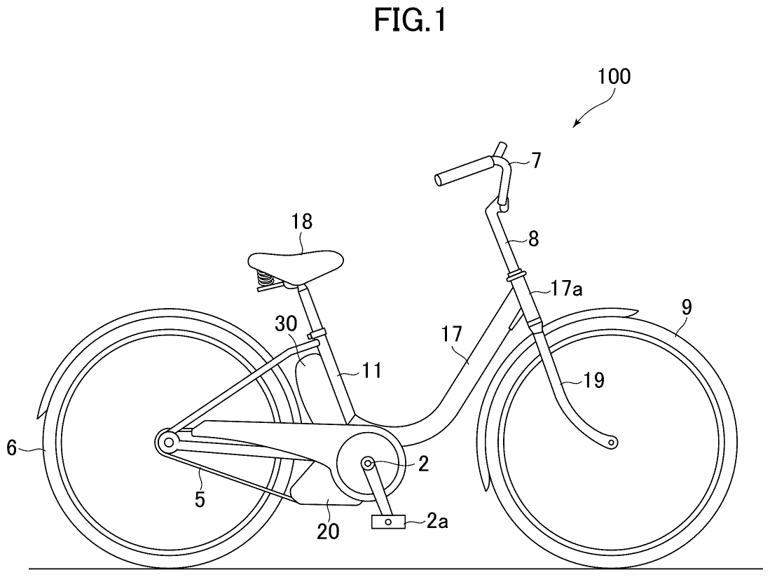

Hereinafter, a battery pack and a manufacturing method of the battery pack according to the present disclosure will be described. FIG. 1 is a side view of an electric power-assisted bicycle 100 that is an example of a vehicle having a battery pack according to the present disclosure. The battery pack according to the present disclosure may be mounted on an electric vehicle (a vehicle that runs only by a driving force of an electric motor such as a two-wheeled electric vehicle, a three-wheeled electric vehicle, or a four-wheeled electric vehicle).

As illustrated in FIG. 1, the bicycle 100 includes a crank shaft 2. A crank arm is attached to an end of the crank shaft 2. A pedal 2a is coupled to an end of the crank arm. The crank shaft 2 is supported at a lower end of a seat tube 11. A saddle 18 is fixed to an upper end of the seat tube 11.

The bicycle 100 includes, at a front thereof, a handle stem 8, a handle 7 fixed to an upper portion of the handle stem 8, a front fork 19 fixed to a lower portion of the handle stem 8, and a front wheel 9 supported at a lower end of the front fork 19. The handle stem 8 is supported by a head pipe 17a provided at a front end of a frame 17. A shape of the frame 17 is not limited to an example illustrated in FIG. 1, and may be appropriately changed.

As illustrated in FIG. 1, the bicycle 100 includes a drive unit 20. The drive unit 20 includes an electric motor that outputs a force to assist driving of a rear wheel 6 (auxiliary torque), and a gear speed reducer. The electric motor is driven by electric power supplied from a battery pack 30. In the example of the bicycle 100, the battery pack 30 is attached to a rear side of the seat tube 11, and the drive unit 20 is disposed on a rear side of the crank shaft 2. A layout of the drive unit 20 and the battery pack 30 is not limited to the example of the bicycle 100, and may be appropriately changed.

The force applied to the crank shaft 2 via the pedal 2a is transmitted to the rear wheel 6 via a chain 5. The power output from the drive unit 20 (torque of the electric motor) is also transmitted to the rear wheel 6 via the chain 5.

### Battery Pack

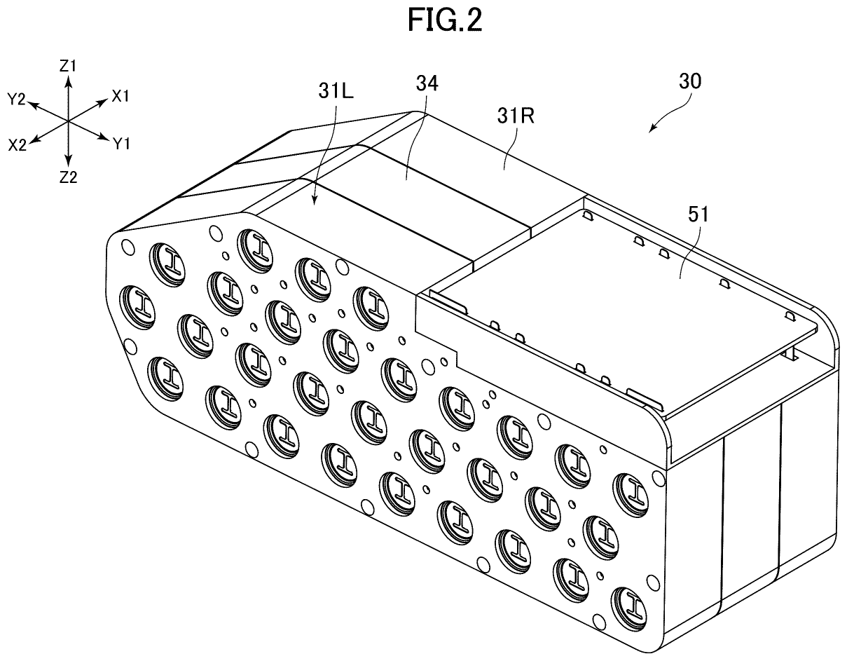

FIGS. 2 to 8 are views illustrating the battery pack 30 that is an example of the battery pack according to the present disclosure. In the drawings, directions indicated by Z1 and Z2 are referred to as a up direction and a down direction, respectively. In the drawings, directions indicated by X1 and X2 are referred to as a right direction and a left direction, respectively, and directions indicated by Y1 and Y2 are referred to as a front direction and a rear direction, respectively. The directions are used to describe relative positions and shapes of parts, members, and components forming the battery pack 30, and do not limit a posture of the battery pack 30 in the vehicle. Therefore, for example, the battery pack 30 may be mounted on the bicycle 100 such that the rear direction (Y2 direction) illustrated in FIG. 2 faces upward of the bicycle 100.

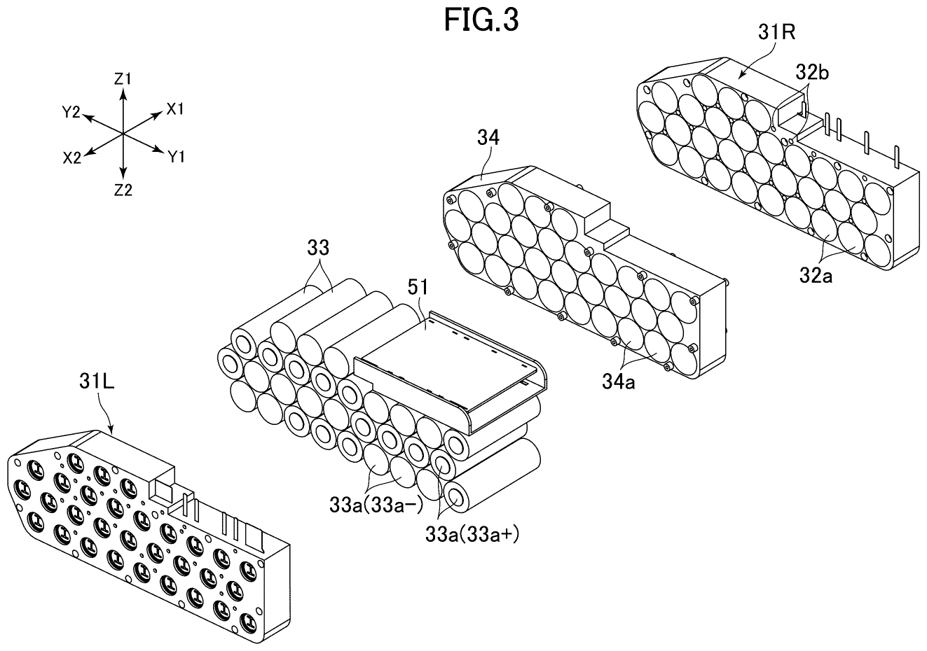

As illustrated in FIG. 3, the battery pack 30 includes a plurality of battery cells 33, a left holder 31L, and a right holder 31R. The battery pack 30 may include a central holder 34 and a circuit board 51. The battery pack 30 may include a housing (not illustrated) that houses the battery cells 33 and the holders 31L and 31R.

### Battery Cell

As illustrated in FIG. 3, the battery cell 33 includes a terminal 33a at an end thereof in the left-right direction. A part of the battery cells 33 are disposed such that a positive terminal 33a+ faces a left side and a negative terminal 33a− faces a right side. The remaining battery cells 33 are disposed such that the positive terminal 33a+ faces the right side and the negative terminal 33a− faces the left side. Each of the battery cells 33 may be cylindrical. The plurality of battery cells 33 is aligned in two directions orthogonal to the left-right direction. More specifically, the plurality of battery cells 33 is aligned in the front-rear direction (Y1-Y2 direction) and in an oblique direction inclined to the front-rear direction and the up-down direction (Z1-Z2 direction).

### Central Holder

As illustrated in FIG. 3, a plurality of holding holes 34a that penetrates the central holder 34 in the left-right direction is formed in the central holder 34. The plurality of battery cells 33 may each be fitted and held in the plurality of holding holes 34a. Unlike the example illustrated in the drawing, the battery pack 30 may not include the central holder 34. Then, the battery cell 33 may be held only by the left holder 31L and the right holder 31R to be described below.

### Left Holder

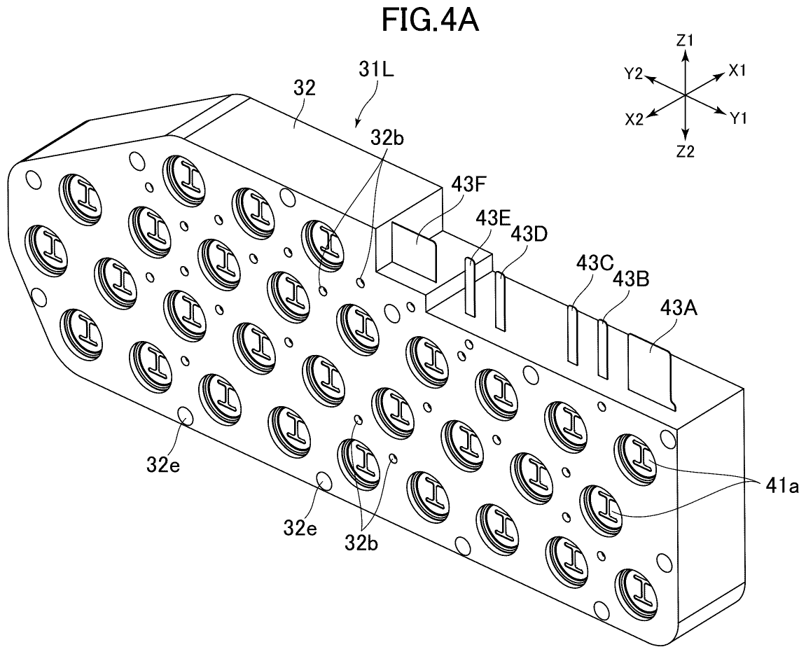

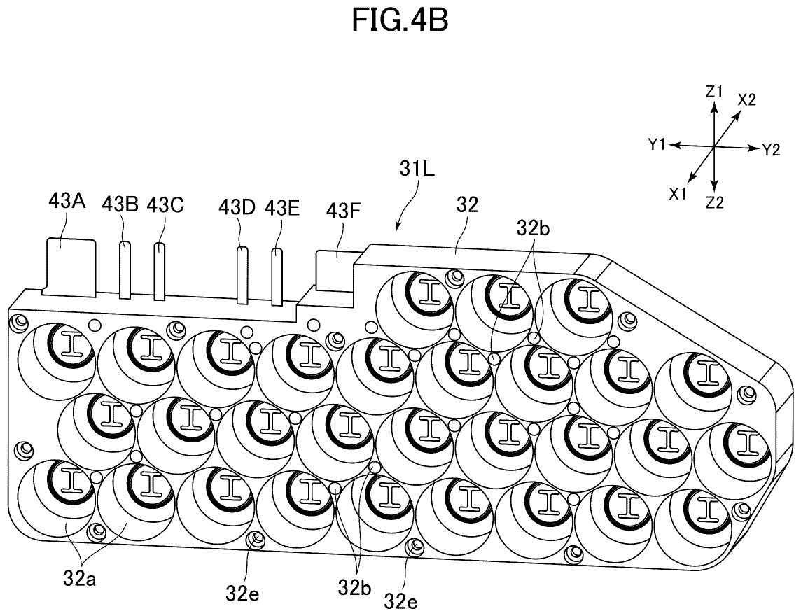

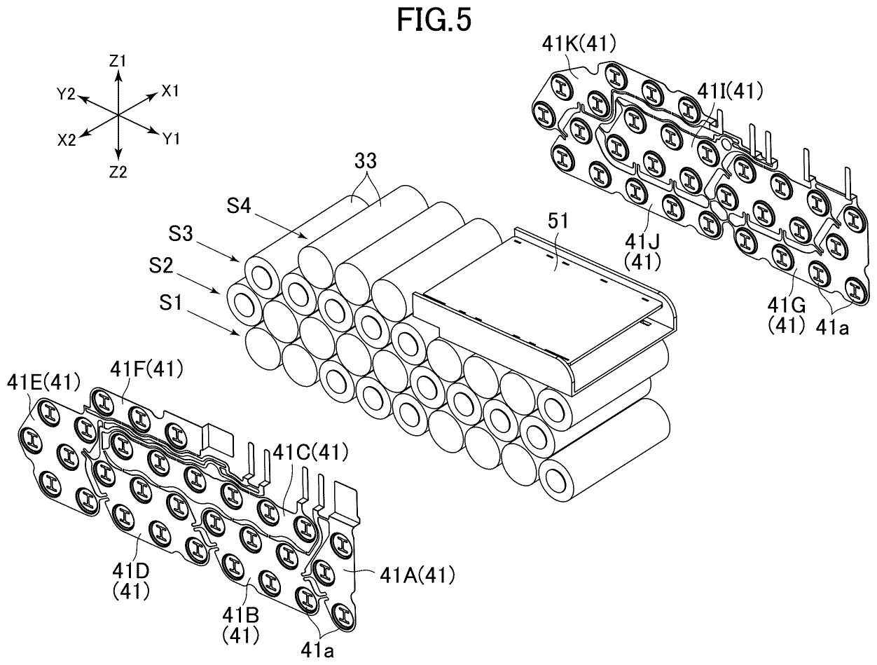

The left holder 31L is disposed on the left side of the plurality of battery cells 33. The left holder 31L includes, as illustrated in FIGS. 4A and 5, a resin portion 32 and a plurality of lead plates 41A to 41F.

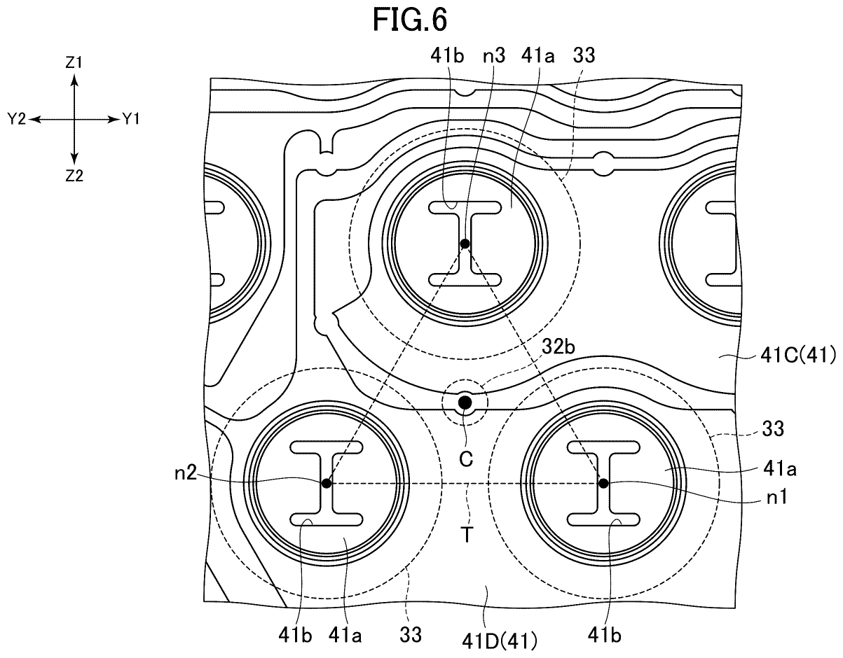

Each of the lead plates 41A to 41F includes a plurality of welding portions 41a. As illustrated in FIG. 5, for example, each of the lead plates 41A and 41F may include three welding portions 41a, and each of the lead plates 41B to 41E may include six welding portions 41a. Each of the welding portions 41a is welded to the left terminal 33a of the battery cell 33. A slit 41b (see FIG. 6) is formed in the welding portion 41a, and an inner edge of the slit 41b may be welded to the terminal 33a. As illustrated in FIG. 6, the slit 41b has substantially an H-shape rotated by, for example, 90 degrees, but the shape is not limited thereto and may be, for example, an I-shape.

As illustrated in FIG. 4B, a plurality of recesses 32a may be formed on a right surface (a surface facing the battery cell 33) of the resin portion 32. Left portions of the plurality of battery cells 33 may each be fitted into the plurality of recesses 32a.

The resin portion 32 and the lead plates 41A to 41F are formed by insert molding. The lead plates 41A to 41F are held by the resin portion 32. More specifically, portions other than the welding portions 41a in the lead plates 41A to 41F are embedded in a material of the resin portion 32.

In the insert molding, the lead plates 41A to 41F (a base component 40L to be described below) are disposed in a cavity of a mold, and then the cavity is filled with molten resin (the material of the resin portion 32). An example of the material of the resin portion 32 may be polycarbonate (PC), acrylonitrile butadiene styrene resin (ABS resin), mixed resin of PC and ABS, polypropylene (PP), polyamide (PA), or polyphenylene sulfide (PPS). When the molten resin is solidified, the resin portion 32 is formed, and the lead plates 41A to 41F are fixed to the resin portion 32. The lead plates 41A to 41F may be fixed to the resin portion 32 without using fasteners such as screws and bolts.

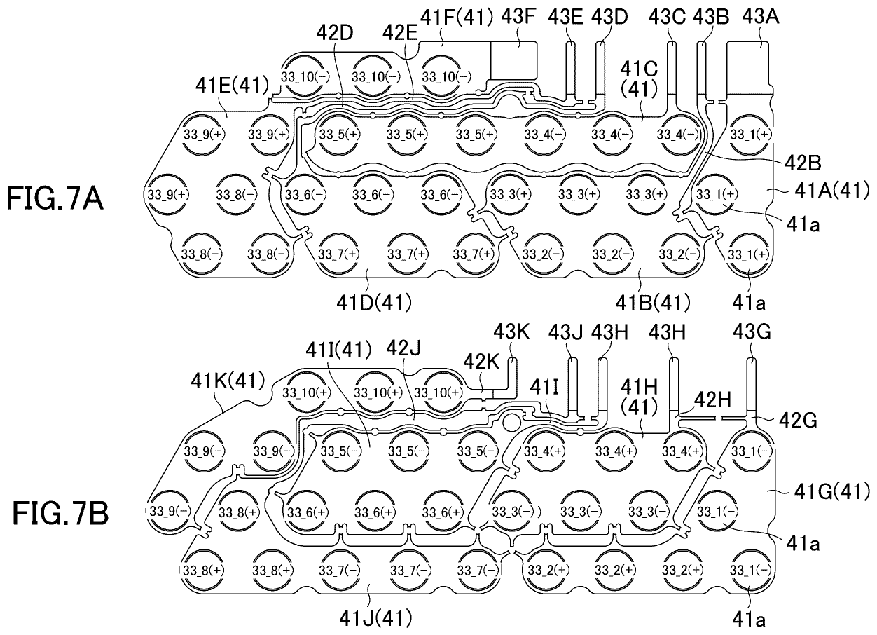

As illustrated in FIG. 7A, the plurality of lead plates 41A to 41F is disposed along a common plane, and do not overlap each other when viewed in the left-right direction. The left holder 31L includes, for example, the six lead plates 41A to 41F. In one example of the battery pack 30, the lead plate 41A is disposed at a forefront. The lead plate 41B is located behind a lower portion of the lead plate 41A, and a front portion of the lead plate 41C is located above the lead plate 41B. The lead plate 41D is located below a rear portion of the lead plate 41C, and the lead plate 41E is located behind the lead plate 41D. The lead plate 41F is located above the rear portion of the lead plate 41C. A number and a layout of the lead plates 41A to 41F are not limited to the example described herein. The number and layout of the lead plates 41A to 41F may be changed according to a number, a layout, and a connection relationship of the battery cells 33 as appropriate.

As illustrated in FIG. 4A, the left holder 31L may include electric power terminals 43A and 43F. The electric power terminals 43A and 43F protrude to an outside of the resin portion 32. During use of the battery pack 30, the battery pack 30 supplies a current to the drive unit 20 via the electric power terminals 43A and 43F. As illustrated in FIG. 7A, for example, the electric power terminal 43A may be formed in the lead plate 41A. For example, the electric power terminal 43F may be formed in the lead plate 41F.

As illustrated in FIG. 4A, the left holder 31L may further include signal terminals 43B to 43E. The signal terminals 43B to 43E also protrude to the outside of the resin portion 32. As illustrated in FIG. 7A, the left holder 31L may include a plurality of signal lines 42B, 42D, and 42E. The signal lines 42B, 42D, and 42E extend from the lead plates 41B, 41D, and 41E respectively. The signal terminal 43B may be formed at an end of the signal line 42B. Similarly, the signal terminal 43D may be formed at an end of the signal line 42D, and the signal terminal 43E may be formed at an end of the signal line 42E. The signal terminal 43C may extend from the lead plate 41C. The terminals 43A to 43F may be disposed at a front portion of the battery pack 30 and aligned in the front-rear direction.

As illustrated in FIG. 2, the signal terminals 43B to 43E may be connected to the circuit board 51. An IC chip for control may be mounted on the circuit board 51 to monitor a state of the battery cell 33. The IC chip may detect voltages of the signal terminals 43B to 43E and monitor the state of the battery cell 33 (more specifically, the battery cell 33 to which the terminals 43B to 43E are connected via the signal lines 42B to 42E) based on the voltages. The electric power terminals 43A and 43F may also be electrically connected to the circuit board 51. The IC chip may detect voltages of the electric power terminals 43A and 43F and monitor the state of the battery cell 33 based on the voltages.

Hereinafter, when the lead plates 41A to 41F are not distinguished in the description, the lead plates are notated by a symbol “41”. When the signal lines 42B to 42E are not distinguished in the description, the signal lines are notated by a symbol “42”, and when the electric power terminals 43A and 43F and the signal terminals 43B to 43E are not distinguished in the description, the terminals are notated by a symbol “43”.

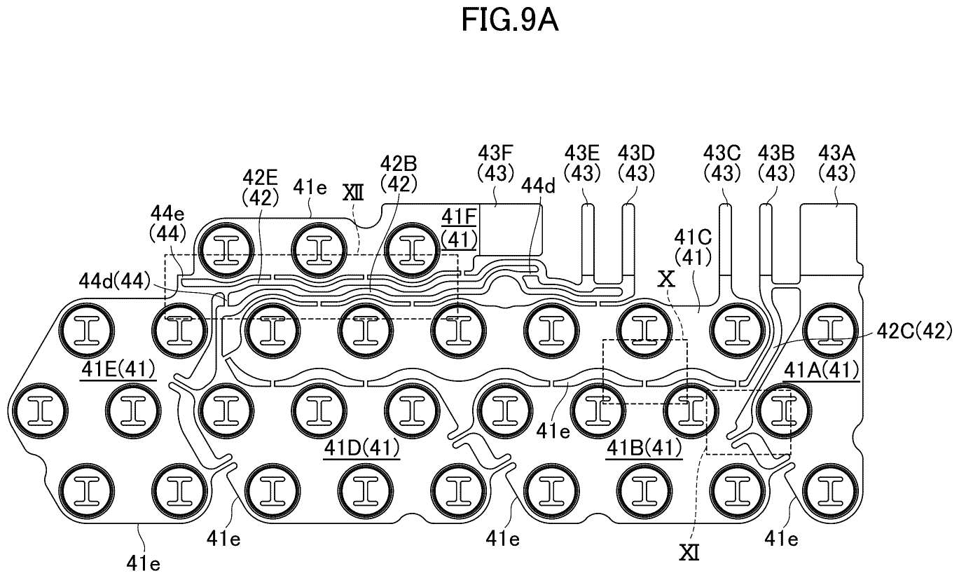

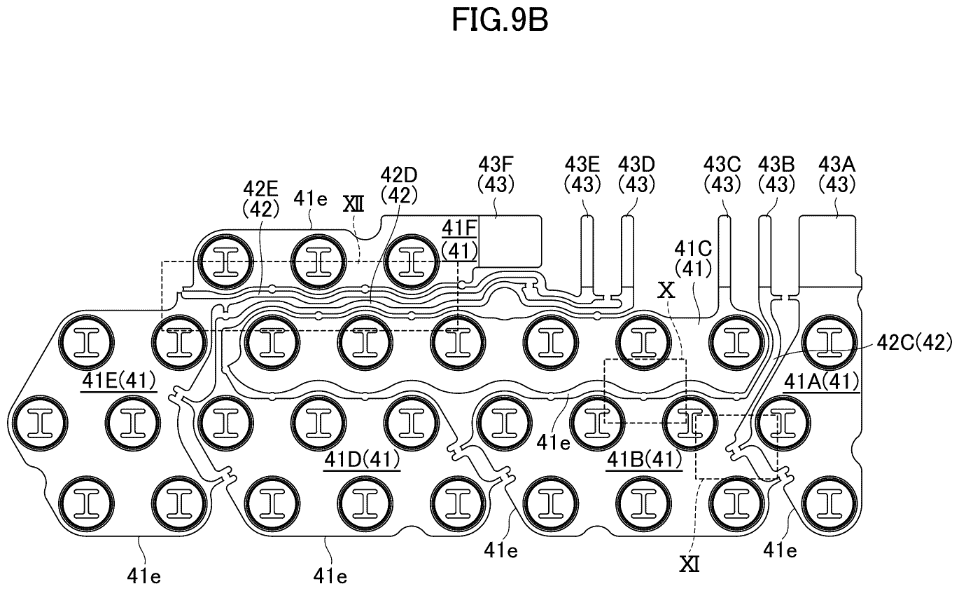

As will be described below in detail, outer edges 41e of the two adjacent lead plates 41 (for example, the lead plates 41A and 41B) are connected to each other by connecting portions 44a, 44b, and 44e (see FIGS. 9A, 10A, and 11A) in the insert molding. Therefore, the plurality of lead plates comprises one metal plate (hereinafter, referred to as “base component 40L”, see FIG. 9A). The signal line 42 also comprises the base component 40L together with the lead plate 41. After the base component 40L is fixed to the resin portion 32 by the insert molding, the connecting portions 44a, 44b, and 44e are cut by presswork, and the plurality of lead plates 41 is separated (a cutting process, see FIG. 9B). To enable the presswork, a through hole 32b (see FIG. 4A) that penetrates the resin portion 32 in the left-right direction is formed in the resin portion 32. The through hole 32b is formed at positions of the connecting portions 44a, 44b, and 44e. During the presswork, the connecting portions 44a, 44b, and 44e are cut with a punch inserted into the through hole 32b.

A plurality of types of connecting portions 44a to 44e (see FIGS. 9A, 10A, 11A, and 12A) are used in the base component 40L (FIG. 9A) that is a base of the plurality of lead plates 41. Hereinafter, when the types are not distinguished in the description, the connecting portions are notated by a symbol “44”.

### Right Holder

As illustrated in FIG. 3, the right holder 31R is disposed on the right side of the plurality of battery cells 33. Similar to the left holder 31L, the right holder 31R includes the resin portion 32 and a plurality of lead plates 41G to 41K (see FIG. 5). Each of the lead plates 41G to 41K includes the plurality of welding portions 41a. Each of the welding portions 41a is welded to the terminal 33a on the right side of the battery cell 33. Similar to the left holder 31L, the slit 41b having substantially an H-shape rotated by 90 degrees may be formed in the welding portion 41a. The resin portion 32 and the lead plates 41G to 41K of the right holder 31R are formed by insert molding, and the lead plates 41G to 41K are held by the resin portion 32.

The plurality recesses 32a (see FIG. 3) may be formed on a left surface (a surface facing the battery cell 33) of the resin portion 32. Right portions of the plurality of battery cells 33 may each be fitted into the plurality of recesses 32a.

As illustrated in FIG. 7B, the right holder 31R may include signal terminals 43G to 43K. The signal terminals 43G to 43K protrude to the outside of the resin portion 32. Similar to the left holder 31L, the right holder 31R may include signal lines 42G to 42K extending from the lead plates 41G to 41K to the signal terminals 43G to 43K.

As illustrated in FIG. 2, the signal terminals 43G to 43K are connected to the circuit board 51. The IC chip for control mounted on the circuit board 51 may detect voltages of the signal terminals 43G to 43K and monitor a state of the battery cell 33 (more specifically, the battery cell 33 welded to the lead plates 41G to 41K to which the terminals 43G to 43K are connected via the signal lines) based on the voltages.

Hereinafter, when the lead plates 41G to 41K are not distinguished in the description, the lead plates are notated by the symbol “41”. When the signal lines 42G to 42K are not distinguished in the description, the signal lines are notated by the symbol “42”, and when the signal terminals 43G and 43K are not distinguished in the description, the terminals are notated by the symbol “43”.

Similar to the lead plate 41 of the left holder 31L, the plurality of lead plates 41 of the right holder 31R is connected to each other by the connecting portion 44 in the insert molding and comprises one metal plate (hereinafter, referred to as a “base component”). The signal line 42 extending from the lead plate 41 also comprises the base component together with the lead plate 41. After the base component is fixed to the resin portion 32 by the insert molding, the connecting portions 44 are cut by presswork, and the plurality of lead plates 41 is separated (by the cutting process). To enable the presswork, the through hole 32b (see FIG. 3) that penetrates the resin portion 32 in the left-right direction is formed in the resin portion 32. The through holes 32b are each formed at positions of the connecting portions 44. During the presswork, the connecting portions 44 are cut with a punch inserted into the through hole 32b.

### Connection of Plurality of Battery Cells

In the battery pack 30, the plurality of battery cells 33 connected in parallel comprise one set. A plurality of sets is connected in series. In the battery pack 30, for example, three battery cells 33 connected in parallel comprise one set. Ten sets are connected in series.

An electrical connection of the battery cell 33 will be described with reference to FIGS. 7A and 7B. FIG. 7A illustrates the lead plate 41 of the left holder 31L. FIG. 7B illustrates the lead plate 41 of the right holder 31R.

In the drawings, a suffix indicating the battery cell 33 welded to the welding portion 41a of the lead plate 41 is marked at a position of the welding portion 41a. For example, a symbol “33_1 (+)” illustrated in FIG. 7A indicates that the welding portion 41a at the position of the symbol is welded to the positive terminal 33a+ of the battery cell 33 in a first set. Similarly, a symbol “33_2 (-)” indicates that the welding portion 41a at the position of the symbol is welded to the negative terminal 33a− of the battery cell 33 in a second set. A symbol “33_1 (-)” illustrated in FIG. 7B indicates that the welding portion 41a at the position of the symbol is welded to the negative terminal 33a− of the battery cell 33 in the first set.

As illustrated in FIG. 7A, the electric power terminal 43A of the battery pack 30 (a positive terminal of the battery pack 30) is formed on the lead plate 41A. The electric power terminal 43F (a negative terminal of the battery pack 30) is formed on the lead plate 41F. The battery cells 33 are electrically connected to the lead plates 41B to 41E of the left holder 31L and the lead plates 41G to 41K of the right holder 31R between the lead plate 41A and the lead plate 41F in the order of (1) to (23) as follows.

(1) The electric power terminal 43A, (2) the lead plate 41A of the left holder 31L, (3) the three battery cells 33 of the first set, (4) the lead plate 41G of the right holder 31R, (5) the three battery cells 33 of the second set, (6) the lead plate 41B of the left holder 31L, (7) three battery cells 33 of a third set, (8) the lead plate 41H of the right holder 31R, (9) three battery cells 33 of a fourth set, (10) the lead plate 41C of the left holder 31L, (11) three battery cells 33 of a fifth set, (12) the lead plate 411 of the right holder 31R, (13) three battery cells 33 of a sixth set, (14) the lead plate 41D of the left holder 31L, (15) three battery cells 33 of a seventh set, (16) the lead plate 41J of the right holder 31R, (17) three battery cells 33 of an eighth set, (18) the lead plate 41E of the left holder 31L, (19) three battery cells 33 of a ninth set, (20) the lead plate 41K of the right holder 31R, (21) three battery cells 33 of a tenth set, (22) the lead plate 41F of the left holder 31L, and (23) the electric power terminal 43F

The lead plate 41A of the left holder 31L includes the three welding portions, 41a, to which the positive terminals 33a+ of the three battery cells 33 are each welded. The lead plate 41F includes the three welding portions 41a to which the negative terminals 33a− of the three battery cells 33 are each welded. In contrast, each of the lead plates 41B to 41E includes the six welding portions 41a. The three welding portions 41a among the six welding portions are each welded to the positive terminals 33a+ of the three battery cells 33, and the remaining three welding portions are each welded to the negative terminals 33a− of the three battery cells 33. Similarly, each of the lead plates 41G to 41K of the right holder 31R includes the three welding portions 41a to which the positive terminals 33a+ of the three battery cells 33 are each welded, and the three welding portions 41a to which negative terminals 33a− of the three battery cells 33 are each welded.

The number of the battery cells 33 forming each set is not limited to three, and may be two or more than three. The number of sets connected in series may be less than ten or more than ten.

### Manufacturing Method of Battery Pack

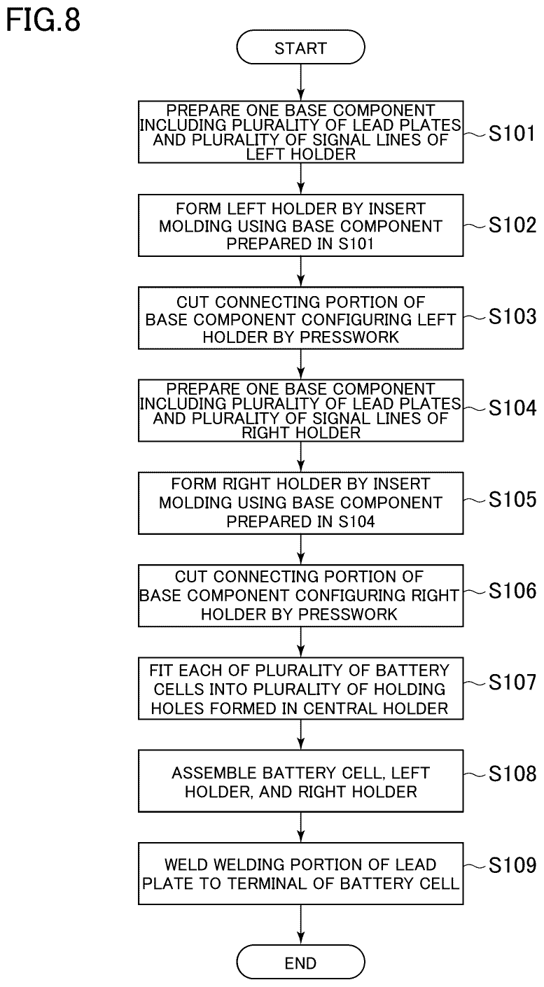

A manufacturing method of the battery pack 30 will be described with reference to FIG. 8.

One base component 40L including a plurality of lead plates 41 and signal lines 42 of the left holder 31L is prepared (S101). For example, a plurality of base components 40L may be cut out from one rectangular metal plate by presswork (punching).

FIG. 9A is a view illustrating an example of the base component 40L. As illustrated in the same drawing, the outer edges 41e of two adjacent lead plates 41 are connected to each other. According to the structure, it is possible to decrease the amount of presswork required to obtain the plurality of lead plates 41 and the number of parts required for presswork. FIG. 9B is a view illustrating the lead plate 41 and the signal line 42 separated by the presswork (the cutting process in S103) performed after the insert molding.

### Connecting portion of Two Lead Plates

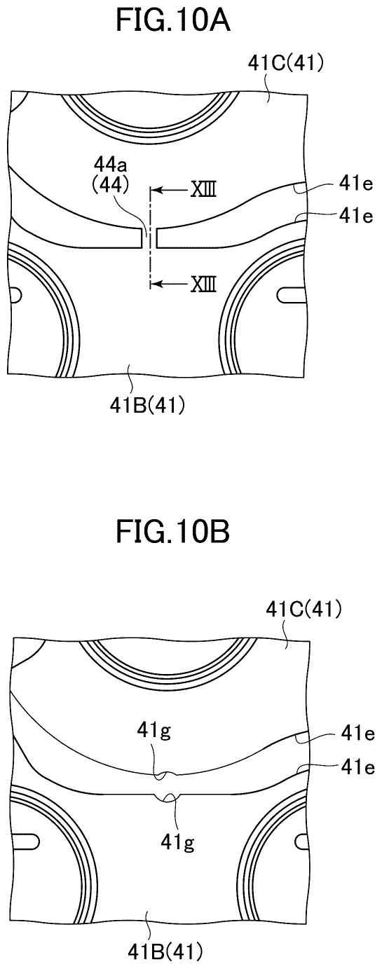

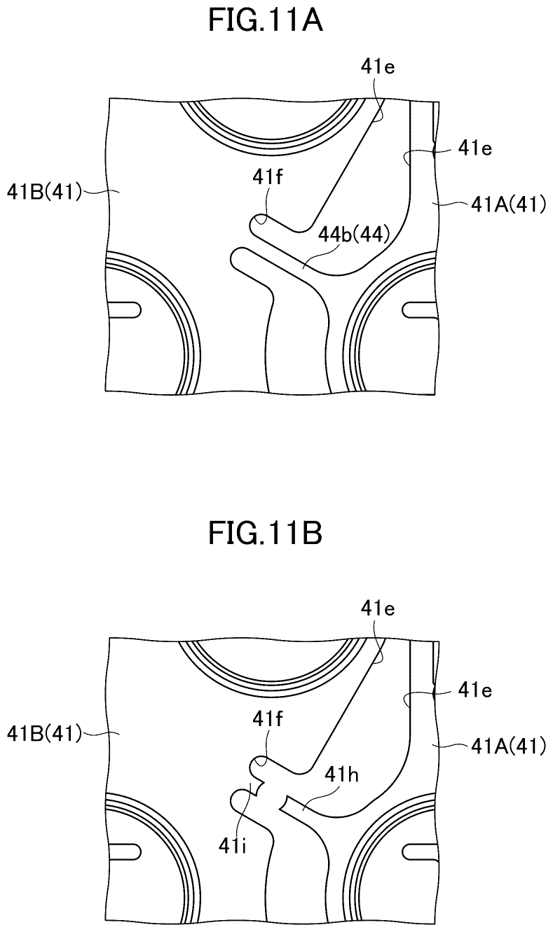

FIGS. 10A and 11A are enlarged views of each of a region X and a region XI in FIG. 9A. As illustrated in FIG. 10A, the outer edge 41e of the lead plate 41B is connected to the outer edge 41e of the lead plate 41C by the connecting portion 44a. The connecting portion 44a extends from the outer edge 41e of one lead plate 41B to the outer edge 41e of another lead plate 41C along a plane parallel to the base component 40L.

As illustrated in FIG. 11A, the outer edge 41e of the lead plate 41A may be connected to the outer edge 41e of the lead plate 41B by the connecting portion 44b. The connecting portion 44b extends from the outer edge 41e of one lead plate 41A to the outer edge 41e of another lead plate 41B along the plane parallel to the base component 40L. A recess 41f is formed in the outer edge 41e of the lead plate 41B. The recess 41f will be described below.

The outer edge 41e of the lead plate 41C and the outer edge 41e of the lead plate 41D are also connected. Similarly, the outer edge 41e of the lead plate 41D and the outer edge 41e of the lead plate 41E are also connected, and the outer edge 41e of the lead plate 41E and the outer edge 41e of the lead plate 41F are also connected.

The two adjacent lead plates 41 may be connected to each other by the plurality of connecting portions 44. Accordingly, the strength of the base component 40L can be increased. For example, the lead plate 41A and the lead plate 41B are connected to each other by the two connecting portions 44b. The lead plate 41B and the lead plate 41C are also connected to each other by the two connecting portions 44a.

One lead plate 41 may be connected to the plurality of lead plates 41 adjacent thereto. For example, the lead plate 41B is connected to the lead plate 41A located in front of the lead plate 41B, the lead plate 41C located above the lead plate 41B, and the lead plate 41D located behind the lead plate 41B. Accordingly, the base component 40L can be used in the manufacture of the battery pack 30, including a large number of the lead plates 41.

### Connecting portion between Signal Line and Lead Plate

As described above, the left holder 31L includes the signal lines 42 each extending from the lead plates 41. The signal lines 42 may be disposed along the outer edge 41e of another lead plate 41 and connected to the outer edge 41e of the other lead plate 41. Accordingly, it is possible to prevent misalignment of the signal lines 42 in the cavity of the mold when insert molding to be described below (in S102) is performed.

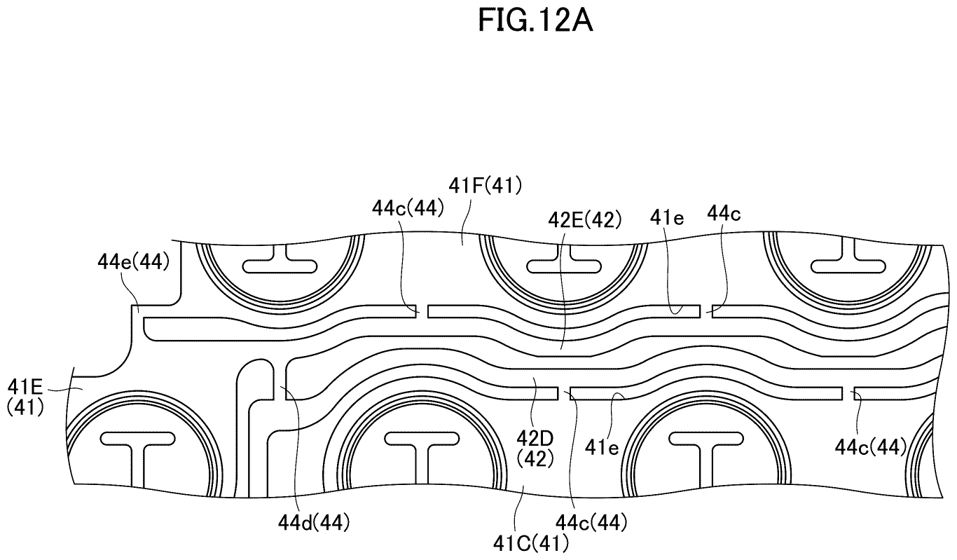

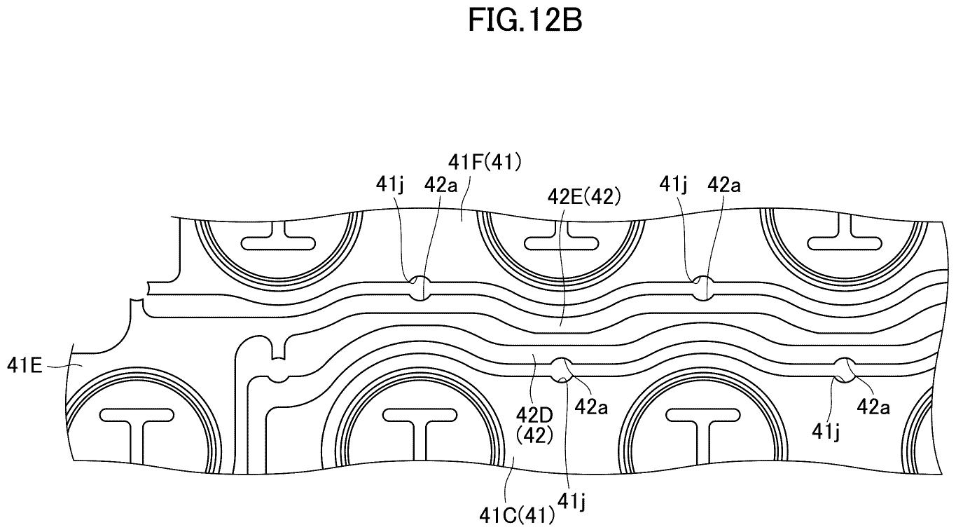

For example, as illustrated in FIG. 12A, the signal line 42D may be disposed along the outer edge 41e of the lead plate 41C. The outer edge 41e of the lead plate 41C is connected to the signal line 42D by the connecting portion 44c. Similar to the connecting portion 44a described above, the connecting portion 44c extends along the plane parallel to the base component 40L.

The outer edge 41e of the lead plate 41C may be connected to the signal line 42D by the plurality of connecting portions 44c aligned at intervals along the outer edge 41e of the lead plate 41C. As illustrated in FIG. 12A, the signal line 42E may be connected to the outer edge 41e of the lead plate 41F by the plurality of connecting portions 44c similarly to the signal line 42D.

### Connecting portion between Two Signal Lines

The plurality of signal lines 42 may be disposed between the outer edges 41e of the two lead plates 41. Here, the plurality of signal lines 42 may be connected to each other via the connecting portion 44. In the example illustrated in FIG. 12A, the two signal lines 42D and 42E are disposed between the outer edge 41e of the lead plate 41F and the outer edge 41e of the lead plate 41C. The two signal lines 42D and 42E are connected to each other via the connecting portion 44d (see FIGS. 9A and 12A). According to the structure, even when the number of the signal lines 42 is large, it is possible to prevent misalignment of each of the signal lines 42.

Unlike the example of FIG. 12A, one signal line 42 may be disposed between the two lead plates 41. Here, the one signal line 42 may be connected to either or both of the two lead plates 41.

### Insert Molding

The left holder 31L is formed by insert molding using the base component 40L (S102). Namely, after the base component 40L is placed in a cavity of a mold, the cavity is filled with molten resin (the material of the resin portion 32) to obtain the resin portion 32 holding the base component 40L. Here, the through holes 32b penetrating the resin portion 32 in the left-right direction are formed at positions corresponding to the plurality of connecting portions 44. The connecting portion 44 is exposed to the right and left sides of the left holder 31L via the through hole 32b. A plurality of fastening holes 32e penetrating the resin portion 32 (see FIG. 4A) may be formed in S102.

### Cutting Process

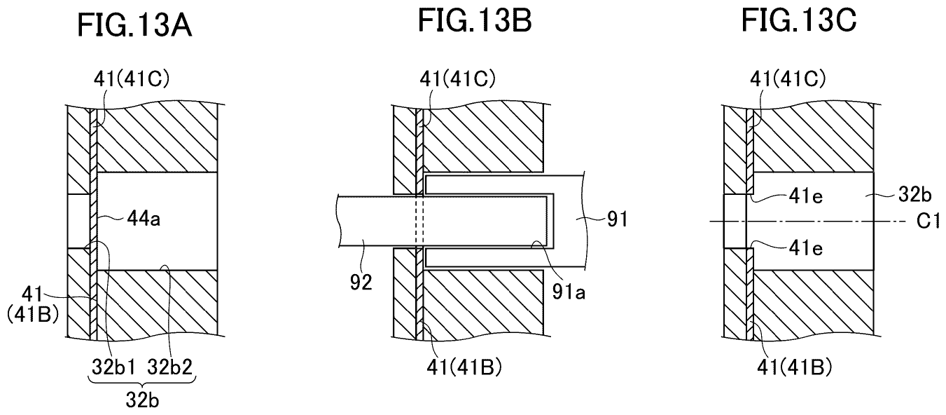

Next, the connecting portion 44 is cut by presswork (more specifically, piercing) to separate the plurality of lead plates 41 and signal lines 42 connected to each other (S103). FIGS. 13A to 13C are cross-sectional views illustrating the cutting process. FIGS. 13A to 13C illustrate, for example, a cross section of the left holder 31L taken along a line XIII-XIII in FIG. 10A.

As illustrated in FIG. 13A, the through hole 32b may include a small-diameter portion 32b1 and a large-diameter portion 32b2. As described above, the connecting portion 44 is exposed to the right and left sides of the left holder 31L via the through hole 32b. As illustrated in FIG. 13B, a die 91 having a recess 91a formed therein is inserted into the large-diameter portion 32b2, and a punch 92 is inserted into the small-diameter portion 32b1. Thus, each of the connecting portions 44 is cut. As a result, as illustrated in FIG. 13C, the two lead plates 41, adjacent to each other, are separated. A shape and a structure of the punch 92 are not particularly limited as long as the connecting portion 44 can be cut.

In the left holder 31L formed as such, the through hole 32b is located between the outer edges 41e of the two lead plates 41, adjacent to each other. More specifically, a center C1 of the through hole 32b (see FIG. 13C) is located between the outer edges 41e of the two lead plates 41, adjacent to each other. As a result, the outer edge 41e of one lead plate 41 and the outer edge 41e of another lead plate 41, each have a portion exposed inside the through hole 32b of the resin portion 32 (see FIG. 13C).

In the cutting process of S103, the plurality of connecting portions 44 may be cut simultaneously. Namely, the plurality of connecting portions 44 may be cut by a single presswork.

The connecting portion 44 connecting the signal line 42 and the lead plate 41 is cut in the same procedure as in the example illustrated in FIGS. 13A to 13C. As a result, the plurality of through holes 32b aligned along the outer edge 41e of the lead plate 41 is formed between the signal line 42 and the outer edge 41e of the lead plate 41. Namely, the center C1 of each of the through holes 32b (see FIG. 13C) is located between the signal line 42 and the outer edge 41e of the lead plate 41. The signal line 42 and the outer edge 41e of the lead plate 41 each have portions exposed inside the through hole 32b.

### Right Holder

The right holder 31R is manufactured similarly to the left holder 31L. Specifically, first, one base component including the plurality of lead plates 41 and the plurality of signal lines 42 of the right holder 31R is prepared (S104). Similar to the base component 40L, the outer edges 41e of the two lead plates 41 adjacent to each other may be connected to each other in the base component. The signal line 42 may be connected to the outer edge 41e of the lead plate 41. The two signal lines 42 adjacent to each other may be connected to each other.

Next, the right holder 31R is formed by insert molding using the base component prepared in S104 (S105). Here, the through holes 32b penetrating the resin portion 32 in the left-right direction are formed at positions corresponding to the plurality of connecting portions 44. The plurality of fastening holes 32e (see FIG. 3) may be formed in the resin portion 32 during the molding in S105.

Next, the connecting portion 44 is cut by presswork (more specifically, piercing) to separate the lead plates 41 and signal lines 42 connected to each other (S106). In the cutting process of S106, the plurality of connecting portions 44 may be cut simultaneously. Namely, the plurality of connecting portions 44 may be cut by a single presswork.

### Assembling Process

Next, the plurality of battery cells 33 is each fitted into the plurality of holding holes 34a formed in the central holder 34 (see FIG. 3) (S107). Then, the battery cells 33, the left holder 31L, and the right holder 31R are assembled in the left-right direction (S108). Here, the holders 31L and 31R may be fixed to each other by inserting fasteners such as bolts and nuts into the fastening holes 32e formed in the resin portions 32 of the holders 31L and 31R. The assembling process is not limited to the above-described procedure. For example, the plurality of battery cells 33 may be fitted into the left holder 31L (or the right holder 31R), the central holder 34 may be fitted into the plurality of battery cells 33, and then the right holder 31R (or the left holder 31L) may be assembled thereto.

### Welding Process

Thereafter, the welding portion 41a of the left holder 31L is welded to the terminal 33a on the left side of the battery cell 33, and the welding portion 41a of the right holder 31R is welded to the terminal 33a on the right side (S109). Thus, the battery pack 30 is obtained.

In S109, when a position of the left holder 31L is aligned with a position of the battery cell 33, the positions of the plurality of lead plates 41 of the left holder 31L coincide with the positions of the battery cells 33. When a position of the right holder 31R is aligned with the position of the battery cell 33, the positions of the plurality of lead plates 41 of the right holder 31R coincide with the positions of the battery cells 33. Accordingly, the welding operation can be facilitated.

### Details of Connecting Portion

A description will be given in detail below about the connecting portion 44 between the two lead plates 41 adjacent to each other and the connecting portion 44 between the lead plate 41 and the signal line 42.

As illustrated in FIG. 10A, the outer edges 41e of the two lead plates 41 adjacent to each other may be connected to each other by the relatively short connecting portion 44a. For example, the connecting portion 44a may be shorter than a diameter of the through hole 32b (more specifically, a diameter of the small-diameter portion 32b1). When the length of the connecting portion 44a is as described above, the entire connecting portion 44a may be cut by the cutting process in S103 and S106 of FIG. 8 as illustrated in FIG. 10B.

By the cutting process, a recess 41g (see FIG. 10B) may be formed in the outer edge 41e of one lead plate 41 and the outer edge 41e of another lead plate 41. When the recess 41g is used, the distance between the outer edges 41e of the two lead plates 41 adjacent to each other can be shortened. As a result, an area of the lead plate 41 can be increased, and an electrical resistance of the lead plate 41 can be lowered. In the finally obtained battery pack 30, an inner edge of the recess 41g is exposed inside the through hole 32b formed in the resin portion 32.

As illustrated in FIG. 11A, the recess 41f may be formed in the outer edge 41e of one lead plate 41 (41B). Then, the connecting portion 44b may extend from the outer edge 41e of another lead plate 41 (41A) and be connected to the inside of the recess 41f. Even in the structure, the distance between the outer edges 41e of the two lead plates 41 adjacent to each other can be shortened. A sufficient length of the connecting portion 44b can be secured. Since the distance between the two outer edges 41e is short, an area of the lead plate 41 can be increased, and an electrical resistance of the lead plate 41 can be lowered.

When the lead plates 41 are connected as illustrated in FIG. 11A, only a part of the connecting portion 44b may be cut as illustrated in FIG. 11B by the cutting process in S103 and S106 of FIG. 8. Then, a part of the connecting portion 44b (a protrusion 41h) may remain on the outer edge 41e of one lead plate 41 (41A). A part of the connecting portion 44b (a protrusion 41i) may also remain on the outer edge 41e of another lead plate 41 (41B). Here, the through hole 32b may be located between the outer edge 41e of one lead plate 41 (41A) and the inner edge of the recess 41f of the other lead plate 41 (41B). More specifically, the center C1 of the through hole 32b (FIG. 13C) may be located between the outer edge 41e of the one lead plate 41 (41A) and the inner edge of the recess 41f of the other lead plate 41 (41B). In the finally obtained battery pack 30, the protrusions 41h and 41i are exposed inside the through hole 32b formed in the resin portion 32.

When the distance between the outer edges 41e of the two lead plates 41, adjacent to each other, is large, the recess 41g illustrated in FIG. 10B and the recess 41f illustrated in FIG. 11A may not be formed. For example, as illustrated in FIG. 9A, the lead plate 41E and the lead plate 41F may be connected to each other via the connecting portion 44e. Here, as illustrated in FIG. 9B, only a midway part of the connecting portion 44e may be cut in the cutting process illustrated in S103 and S106 of FIG. 8.

The connecting portions 44a, 44b, and 44e described above may be applied for connections of the other lead plates 41D, 41E, and 41F.

As illustrated in FIG. 12A, the lead plate 41 (41C) and the signal line 42 (42D) may also be connected to each other by the relatively short connecting portion 44c. For example, the connecting portion 44c may be shorter than the diameter of the through hole 32b (more specifically, the diameter of the small-diameter portion 32b1). When the length of the connecting portion 44c is as described above, the entire connecting portion 44c may be cut by the cutting process in S103 and S106 of FIG. 8 as illustrated in FIG. 12B.

By the cutting process, a recess 41j (see FIG. 12B) may be formed in the outer edge 41e of the lead plate 41, and a recess 42a (see FIG. 12B) may be formed on an edge of the signal line 42. According to the structure, the distance between the outer edge 41e of the lead plate 41 and the signal line 42 can be shortened. As a result, an area of the lead plate 41 can be increased and a thickness of the signal line 42 can also be increased, whereby an electrical resistance of the lead plate and the signal line can be lowered. The connection structure can be applied to a connection structure between another signal line and another lead plate (for example, a connection structure between the signal line 42E and the lead plate 41F).

### Position of Through Hole

The plurality of battery cells 33 aligned in the front-rear direction comprises a plurality of columns. As illustrated in FIG. 5, the plurality of battery cells 33 forms a first column S1, a second column S2, a third column S3, and a fourth column S4. Positions of the battery cells 33 disposed in two adjacent columns are misaligned in the front-rear direction. As a result, when the battery cells 33 are viewed in the left-right direction as illustrated in FIG. 6, three adjacent battery cells 33 are located at vertices n1 to n3 of an equilateral triangle T respectively. For example, centers of the three battery cells 33 may be located at the vertices n1 to n3 of the equilateral triangle T respectively. According to the arrangement of the battery cells 33, an arrangement density of the battery cells 33 can be increased, and the battery pack 30 can be miniaturized.

The description “the three battery cells 33 are located at the vertices n1 to n3 of the equilateral triangle T respectively” does not necessarily mean that positions of centers C of the three battery cells 33 completely coincide with positions of the vertices n1 to n3 respectively. Namely, the positions of the centers C of the three battery cells 33 may be misaligned with the positions of the vertices n1 to n3 respectively. Here, when the three battery cells 33 are viewed in the left-right direction, the vertices n1 to n3 may overlap a part of the three battery cells 33 respectively.

As described above, the through holes 32b are provided in the resin portion 32 at the positions of the connecting portions 44a to 44e (FIGS. 10A, 11A, and 12A). When the battery cells 33 are viewed in the left-right direction as illustrated in FIG. 6, the through hole 32b is formed at the center C of the equilateral triangle T. When the position of the through hole 32b is set as such, a sufficient distance between the through hole 32b and the battery cell 33 can be secured.

The description “the through hole 32b is formed at the center C of the equilateral triangle T” does not necessarily mean that the center of the through hole 32b completely coincides with the center C of the equilateral triangle T. Namely, the center of the through hole 32b may be misaligned with the center C of the equilateral triangle T. Here, the center C of the equilateral triangle T may be located inside of the through hole 32b (inside of the large-diameter portion 32b2).

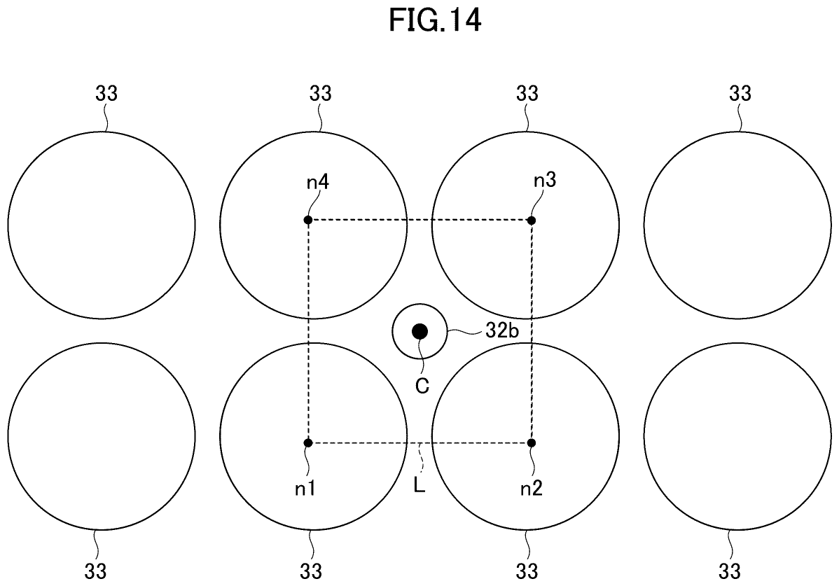

The arrangement of the battery cells 33 is not limited to the example illustrated in FIG. 6. FIG. 14 is a view illustrating a modified example of a layout of the battery cells 33. In the drawing, four adjacent battery cells 33 are located at vertices n1 to n4 of a square L respectively. For example, centers of the four battery cells 33 may be located at the vertices n1 to n4 of the square L respectively. Here, the through hole 32b may be formed at a center C of the square L. When the position of the through hole 32b is set as such, the distance between the through hole 32b and the battery cell 33 can be secured.

The description “the four battery cells 33 are located at the vertices n1 to n4 of the square L respectively” does not necessarily mean that positions of centers C of the four battery cells 33 completely coincide with positions of the vertices n1 to n4 respectively. Namely, the positions of the centers C of the four battery cells 33 may be misaligned with the positions of the vertices n1 to n4 respectively. Here, when the four battery cells 33 are viewed in the left-right direction, the vertices n1 to n4 may overlap a part of the four battery cells 33 respectively. The description “the through hole 32b may be formed at the center C of the square L” does not necessarily mean that the center of the through hole 32b completely coincides with the center C of the square L. Namely, the center of the through hole 32b may be misaligned with the center C of the square L. Here, the center C of the square L may be located inside of the through hole 32b (inside of the large-diameter portion 32b2).

### Summary

(1) As described above, the battery pack 30 includes the plurality of battery cells 33 each including the terminal 33a at an end in the left-right direction, and the left holder 31L. The left holder 31L includes the resin portion 32 molded from resin, and the plurality of lead plates 41 held by the resin portion 32. The plurality of battery cells 33 is aligned in two directions orthogonal to the left-right direction. The plurality of lead plates 41 includes the first lead plate 41 (for example, the lead plate 41B) connected to the terminal 33a of the first battery cell 33, and the second lead plate 41 (for example, the lead plate 41C) connected to the terminal 33a of another battery cell 33. In the resin portion 32, the first through hole 32b penetrating the resin portion 32 in the left-right direction is formed. The first through hole 32b is located between the outer edges 41e of the two lead plates 41.

According to the battery pack 30, the manufacturing process thereof can be simplified. For example, a process in which the left holder 31L is formed by insert molding using the base component 40L including the plurality of lead plates 41 connected to each other and then the lead plates 41 connected to each other are separated with the punch 92 inserted into the first through hole 32b can be performed. Thus, it is possible to decrease the amount of presswork required to obtain the plurality of lead plates 41 and the number of parts required for presswork. When a position of the left holder 31L is aligned with a position of the battery cell 33, the positions of the plurality of lead plates 41 coincide with the positions of the battery cells 33. As a result, the welding operation of the lead plates 41 of the left holder 31L and the battery cells 33 can be facilitated.
(2) In the structure of (1), the outer edges 41e of the two lead plates 41 each have the portion exposed inside the first through hole 32b.
(3) In the structure of (1) or (2), the three battery cells 33 adjacent to each other may be located at the vertices n1 to n3 of the equilateral triangle T respectively when the battery cells 33 are viewed in the left-right direction. The first through hole 32b may be located at the center C of the equilateral triangle T. According to the structure, a sufficient distance between the first through hole 32b and the battery cell 33 is secured with ease.
(4) In the structure of (1) or (2), the four battery cells 33 adjacent to each other may be located at the vertices n1 to n4 of the square L respectively when the plurality of battery cells 33 is viewed in the left-right direction. The center C of the square L may be located inside the first through hole 32b. According to the structure, a sufficient distance between the first through hole 32b and the battery cell 33 is secured with ease.
(5) In the structure of any one of (1) to (4), the left holder 31L may include the signal line 42 (for example, the signal line 42D) electrically connected to the circuit board 51 and the lead plate 41 (for example, the lead plate 41C). The signal line 42 may be disposed along the outer edge 41e of the lead plate 41. In the resin portion 32, a second through hole 32b penetrating the resin portion 32 in the left-right direction may be formed. The second through hole 32b may be located between the signal line 42 and the outer edge 41e of the lead plate 41.

According to the structure, it is possible to enable a manufacturing method of forming the left holder 31L by insert molding using the base component 40L including the signal line 42 and the lead plate 41 connected to each other and then separating the lead plate 41 and the signal line 42 connected to each other with the punch 92 inserted into the second through hole 32b. Accordingly, when the position of the left holder 31L is aligned with the position of the battery cell 33, the position of the signal line 42 can be optimized, whereby the battery pack 30 can be easily assembled.
(6) In the structure of (5), the signal line 42 and the outer edge 41e of the lead plate 41 each have a portion exposed inside the second through hole 32b.
(7) In the structure of any one of (1) to (6), the recess 41g may be formed in the outer edge 41e of the lead plate 41 (for example, the lead plate 41B). The inner edge of the recess 41g may be exposed in the first through hole 32b. According to the structure, it is possible to shorten the distance between the outer edges 41e of the two lead plates 41 adjacent to each other. As a result, the area of each of the lead plates 41 can be increased, and the electrical resistance of the lead plate 41 can be lowered.
(8) In the structure of (7), the recess 41g may be formed in the outer edge 41e of the other lead plate 41 (for example, the lead plate 41C). The inner edge of the recess 41g may be exposed in the first through hole 32b. According to the structure, it is possible to further shorten the distance between the outer edges 41e of the two lead plates 41 adjacent to each other.
(9) In the structure of any one of (1) to (6), the outer edge 41e of one lead plate 41 (for example, the lead plate 41A) may include the protrusion 41h extending toward the outer edge 41e of another lead plate 41 (for example, the lead plate 41B). The protrusion 41h may be exposed inside the first through hole 32b.
(10) In the structure of (9), the recess 41f may be formed in the outer edge 41e of the lead plate 41B. The first through hole 32b may be located between the outer edge 41e of the lead plate 41A and the inner edge of the recess 41f formed in the outer edge 41e of the lead plate 41B. According to the structure, the distance between the outer edge 41e of the lead plate 41B and the outer edge 41e of the lead plate 41A can be shortened. As a result, the area of each of the lead plates 41A and 41B can be increased, and the electrical resistance of each of the lead plates 41A and 41B can be lowered.
(11) In the structure of any one of (1) to (10), the battery pack 30 may include the right holder 31R disposed on the right side of the battery cell 33. The right holder 31R includes the resin portion 32 molded from resin, and the plurality of lead plates 41 held by the resin portion 32. Also in the resin portion 32 of the right holder 31R, the third through hole 32b penetrating the resin portion 32 in the left-right direction is formed. The third through hole 32b is located between the outer edges 41e of the two lead plates 41 adjacent to each other.

According to the battery pack 30, a manufacturing method in which the right holder 31R is formed by insert molding using the base component 40L including the plurality of lead plates 41 connected to each other and then the lead plates 41 connected to each other are separated with the punch 92 inserted into the third through hole 32b is possible. Thus, it is possible to decrease the amount of presswork required to obtain the plurality of lead plates 41 and the number of parts required for presswork. When the position of the right holder 31R is aligned with the position of the battery cell 33, the positions of the plurality of lead plates 41 coincide with the positions of the battery cells 33. As a result, the welding operation of the lead plate 41 of the right holder 31R and the battery cell 33 can be facilitated.
(12) As described above, the manufacturing method of the battery pack 30 includes: a process of preparing the base component 40L including the plurality of lead plates 41 and the first connecting portion 44 (for example, the first connecting portion 44a) connecting the outer edges 41e of the two lead plates 41 (for example, the lead plates 41B and 41C) adjacent to each other; a molding process of forming the left holder 31L including the resin portion 32 that holds the base component 40L by insert molding and forming the first through hole 32b at the position corresponding to the first connecting portion 44 in the resin portion 32; and a cutting process of cutting the connecting portion 44 with the punch 92 inserted into the first through hole 32b.

According to the manufacturing method, it is possible to decrease the amount of presswork required to obtain the plurality of lead plates 41 and the number of parts required for presswork. When the position of the left holder 31L is aligned with the position of the battery cell 33, the positions of the plurality of lead plates 41 coincide with the positions of the battery cells 33. As a result, the welding operation of the lead plate 41 of the left holder 31L and the battery cell 33 can be facilitated.
(13) The manufacturing method of (12) further includes a process of disposing the left holder 31L on the left side of the plurality of battery cells 33 and welding the terminal 33a of the battery cell 33 to the lead plate 41.
(14) In the manufacturing method of (13), the three battery cells 33 adjacent to each other may be located at the vertices n1 to n3 of the equilateral triangle T respectively when the battery cells 33 are viewed in the left-right direction. In the molding process, the first through hole 32b penetrating the resin portion 32 may be formed at the center C of the equilateral triangle T. According to the manufacturing method, a sufficient distance between the first through hole 32b and the battery cell 33 is secured with ease.
(15) In the manufacturing method of (13), the four battery cells 33 adjacent to each other may be located at the vertices n1 to n4 of the square L respectively when the plurality of battery cells 33 is viewed in the left-right direction. In the insert molding, the first through hole 32b penetrating the resin portion 32 may be formed at the center C of the square L. According to the manufacturing method, a sufficient distance between the first through hole 32b and the battery cell 33 is secured with ease.
(16) In the manufacturing method of any one of (12) to (15), the base component 40L may include the signal line 42 (for example, the signal line 42D) disposed along the outer edge 41e of the lead plate 41 (for example, the lead plate 41C), and a second connecting portion 44 (for example, the second connecting portion 44c) connecting the outer edge 41e of the lead plate 41 and the signal line 42. In the molding process, a second through hole 32b penetrating the resin portion 32 may be formed at the position corresponding to the second connecting portion 44. Thereafter, the second connecting portion 44 may be cut with the punch 92 inserted into the second through hole 32b.

The battery pack and the manufacturing method thereof according to the present disclosure are not limited to the above-described examples.

For example, the layout of the lead plate 41 is not limited to the example illustrated in FIGS. 7A and 7B and the like, and may be changed as appropriate.

The shape of the connecting portion 44 connecting the outer edges 41e of the two lead plates 41 adjacent to each other and the shape of the connecting portion 44 connecting the signal line 42 and the lead plate 41 are not limited to the examples illustrated in FIGS. 10A, 11A, and 12A. All of the connecting portions 44 of the base component 40L may have a sufficient length, and only a part of the connecting portions 44 may be cut in the cutting processes in S103 and S106 of FIG. 8. In the finally obtained holders 31R and 31L, the recesses 41f, 41g, and 41j illustrated in FIGS. 10A, 11A, and 12A may not be formed.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A battery pack comprising:
a plurality of battery cells each including a terminal at an end on a first side in a first direction; and
a first holder disposed on the first side of the plurality of battery cells, the first holder including a resin portion molded from resin and a plurality of lead plates held by the resin portion, wherein
the plurality of battery cells includes a first battery cell and a second battery cell aligned in a second direction intersecting with the first direction,
the plurality of lead plates includes a first lead plate having a first edge and a second lead plate having a second edge facing the first edge in the second direction, the first lead plate being connected to the terminal of the first battery cell, and the second lead plate being connected to the terminal of the second battery cell,
in the resin portion, a first through hole penetrating the resin portion in the first direction is formed, and
the first through hole is located between the first edge of the first lead plate and the second edge of the second lead plate.

2. The battery pack according to claim 1, wherein
the first edge of the first lead plate and the second edge of the second lead plate each have a portion exposed inside the first through hole.

3. The battery pack according to claim 1, wherein
the plurality of battery cells further includes a third battery cell,
the first battery cell, the second battery cell, and the third battery cell are located at vertices of an equilateral triangle respectively, when the plurality of battery cells is viewed in the first direction, and
the first through hole is located at a center of the equilateral triangle when the plurality of battery cells is viewed in the first direction.

4. The battery pack according to claim 1, wherein
the plurality of battery cells further includes a third battery cell and a fourth battery cell,
the first battery cell, the second battery cell, the third battery cell, and the fourth battery cell are located at vertices of a square respectively when the plurality of battery cells is viewed in the first direction, and
the first through hole is located at a center of the square when the plurality of battery cells is viewed in the first direction.

5. The battery pack according to claim 1, further comprising:
a circuit board, wherein
the first holder includes a signal line electrically connected to the circuit board, and a third lead plate,
the signal line is disposed along a third edge of the third lead plate, and
in the resin portion, a second through hole penetrating the resin portion in the first direction is formed, the second through hole being located between the signal line and the third edge of the third lead plate.

6. The battery pack according to claim 5, wherein
the signal line and the third edge of the third lead plate each have a portion exposed inside the second through hole.

7. The battery pack according to claim 1, wherein
a recess is formed in the first edge of the first lead plate, and
an inner edge of the recess formed in the first edge is exposed inside the first through hole.

8. The battery pack according to claim 7, wherein
a recess is formed in the second edge of the second lead plate, and
an inner edge of the recess formed in the second edge is exposed inside the first through hole.

9. The battery pack according to claim 1, wherein
the first edge of the first lead plate includes a protrusion extending toward the second edge of the second lead plate, and
the protrusion is exposed inside the first through hole.

10. The battery pack according to claim 9, wherein
a recess is formed in the second edge of the second lead plate, and
the first through hole is located between the first edge of the first lead plate and an inner edge of the recess formed in the second edge.

11. The battery pack according to claim 1, wherein
the plurality of battery cells each includes a terminal at an end on a second side in the first direction,
the battery pack includes a second holder disposed on the second side of the plurality of battery cells, the second holder including a resin portion molded from resin and a plurality of lead plates held by the resin portion,
the plurality of battery cells includes a fifth battery cell and a sixth battery cell,
the plurality of lead plates of the second holder includes a fourth lead plate and a fifth lead plate,
in the resin portion of the second holder, a third through hole penetrating the resin portion in the first direction is formed, and
the third through hole is located between an edge of the fourth lead plate and an edge of the fifth lead plate.

12. A manufacturing method of a battery pack, the method comprising:
a process of preparing a base component including a first lead plate, a second lead plate aligned with the first lead plate, and a first connecting portion connecting an edge of the first lead plate and an edge of the second lead plate;
a molding process of forming a holder including a resin portion that holds the base component by insert molding and forming a first through hole at a position corresponding to the first connecting portion in the resin portion; and
a cutting process of cutting the connecting portion with a punch inserted into the first through hole.

13. The manufacturing method of a battery pack according to claim 12, the method further comprising:
a process of preparing a plurality of battery cells including a first battery cell and a second battery cell, the plurality of battery cells each including a terminal at an end on a first side in a first direction; and
a process of disposing the holder on the first side of the plurality of battery cells, welding the terminal of the first battery cell to the first lead plate, and welding the terminal of the second battery cell to the second lead plate.

14. The manufacturing method of a battery pack according to claim 13, wherein
the plurality of battery cells further includes a third battery cell,
the first battery cell, the second battery cell, and the third battery cell are disposed at vertices of an equilateral triangle respectively when the plurality of battery cells is viewed in the first direction, and
the first through hole is formed at a center of the equilateral triangle.

15. The manufacturing method of a battery pack according to claim 13, wherein
the plurality of battery cells further includes a third battery cell and a fourth battery cell,
the first battery cell, the second battery cell, the third battery cell, and the fourth battery cell are disposed at vertices of a square respectively when the plurality of battery cells is viewed in the first direction, and
the first through hole is formed at a center of the square.

16. The manufacturing method of a battery pack according to claim 12, wherein
the base component includes a third lead plate, a signal line disposed along an edge of the third lead plate, and a second connecting portion connecting the edge of the third lead plate and the signal line,
the molding process includes forming a second through hole penetrating the resin portion at a position corresponding to the second connecting portion, and
the cutting process includes cutting the second connecting portion with a punch inserted into the second through hole.
